(19) United States
(12) Patent Application Publication
(10) Pub. No.: US 2008/0182554 A1
(43) Pub. Date: Jul. 31, 2008

(54) Burglarproof mechanism for portable phone

(75) Inventor: Tien Fan, Shanghai (CN)

Correspondence Address: Joe McKinney Muncy, PO Box 1364, Fairfax, VA, 22038-1364, US

(73) Assignee: Inventec Appliances Corp.

(21) Appl. No.: 11/889,954

(22) Filed: Aug. 17, 2007

(30) Foreign Application Priority Data
Jan. 26, 2007 (TW) 96103082

(51) Int. Cl. H04M 1/667

(52) U.S. Cl. 455/410

(57) ABSTRACT

A burglarproof mechanism for a portable phone is described. A portable phone is provided with a matched hand-free wireless earphone. A periodical communication established between the portable phone and the matched hand-free wireless earphone. The portable phone and the hand-free wireless earphone are provided with a warning action. When the periodical communication is not established, the warning action of at least one of the portable phone and the hand-free wireless earphone is executed.

### RELATED APPLICATIONS

This application claims priority to Taiwan Application Serial Number 96103082, filed Jan. 26, 2007, which is herein incorporated by reference.

### BACKGROUND

1. Field of Invention

The present invention relates to a burglarproof mechanism. More particularly, the present invention relates to a burglarproof mechanism for a portable phone.

2. Description of Related Art

Cellular phone is one of the important personal belongings in modern country. A cellular phone is equipped with several functionalities, such as picture taking, radio broadcast receiving and MP3 playing. Thus, the value of the cellular phone is enhanced. Once a cellular phone is lost or stolen, it is difficult to search back the cellular phone, and the cellular phone owner accordingly loses a valuable property.

For the forgoing reasons, there is a need for a cellular phone burglarproof mechanism.

### SUMMARY

It is therefore an objective of the present invention to provide a burglarproof mechanism for a portable phone.

In accordance with the foregoing and other objectives of the present invention, a burglarproof mechanism for a portable phone comprises the following steps. A portable phone is provided with a matched hand-free wireless earphone. A periodical communication is established between the portable phone and the hand-free wireless earphone. The portable phone and the hand-free wireless earphone are provided with a warning action. When the periodical communication is not established, the warning action of at least one of the portable phone and the hand-free wireless earphone is executed.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a portable phone with a hand-free wireless earphone according to one embodiment of this invention; and

FIG. 2 illustrates a flowchart of a burglarproof mechanism for a portable phone according to one embodiment of this invention; and

FIG. 3 illustrates another flowchart of a burglarproof mechanism for a portable phone according to another embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

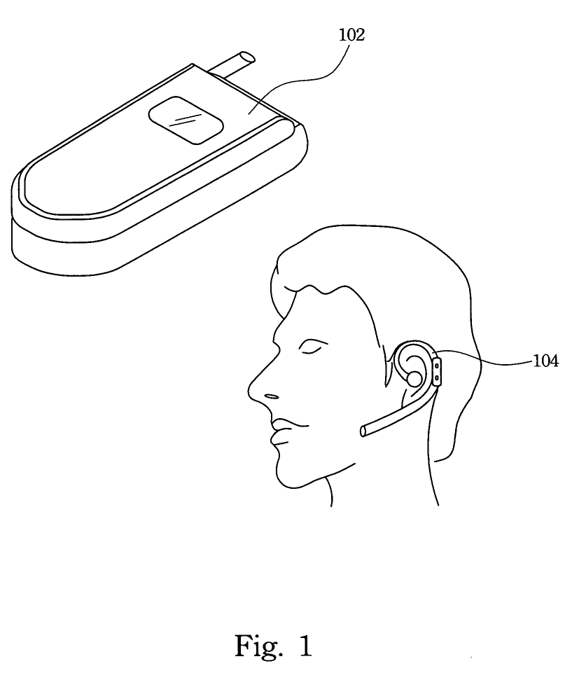

FIG. 1 illustrates a portable phone with a hand-free wireless earphone according to one embodiment of this invention. The portable phone 102 and the hand-free wireless earphone 104 should both be equipped with a speaker and a microphone to facilitate a communication. The portable phone 102 and the hand-free wireless earphone 104 may both be equipped more elements, like a light-emitting device (like light-emitting diode) or a vibration generator, to facilitate a burglarproof mechanism. A wireless communication protocol, such as bluetooth communication protocol, is used to establish a communication between the portable phone 102 and the hand-free wireless earphone 104.

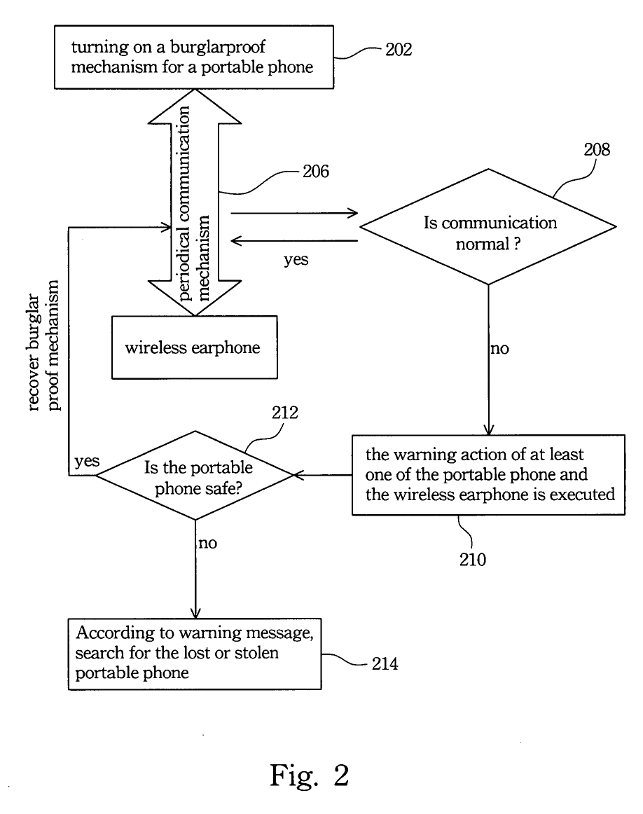

FIG. 2 illustrates a flowchart of a burglarproof mechanism for a portable phone according to one embodiment of this invention. Present burglarproof mechanism is established based on a communication mechanism between the portable phone 102 and the hand-free wireless earphone 104. In step 206 and step 208, either one of the portable phone 102 and its matched hand-free wireless earphone 104 successfully sends a radio signal to the other and receives a responsive radio signal from the other periodically (any interval between adjacent radio signals is the same as the other interval between other adjacent radio signals) when the portable phone 102 and the hand-free wireless earphone 10 are both within a predetermined zone, i.e. a circular zone with a diameter of 10˜12 meters. In step 210, when either one of the portable phone 102 and the hand-free wireless earphone 104 cannot successfully receive a radio signal from the other periodically, a warning action is executed on at least one of the portable phone 102 and the hand-free wireless earphone 104. The warning action of the hand-free wireless earphone 104 enables an owner to search for the matched portable phone 102. The warning action of the portable phone 102 may stop a theft in time.

A specified warning sound, which is generated by a speaker of the hand-free wireless earphone 104 or the portable phone 102, can serve as a warning action. Alternately, a specified warning light-emitting, which is generated by a light-emitting device of the hand-free wireless earphone 104 or the portable phone 102, may be accompanied with the specified warning sound to serve as a warning action, or alone serve as a warning action. Alternately, a specified warning vibration, which is generated by a vibration generator of the hand-free wireless earphone 104 or the portable phone 102, may be accompanied with the specified warning sound or the specified warning light-emitting to serve as a warning action, or alone serve as a warning action. The specified warning vibration and specified warning light-emitting would easily warn a hearing-impaired person that his or her portable phone may be stolen or lost.

When either one of the portable phone 102 and the hand-free wireless earphone 104 cannot successfully receive a radio signal from the other periodically, the portable phone 102 may be stolen, lost or lose power. Therefore, the owner needs to confirm if the portable phone 102 is safe or not (step 212).

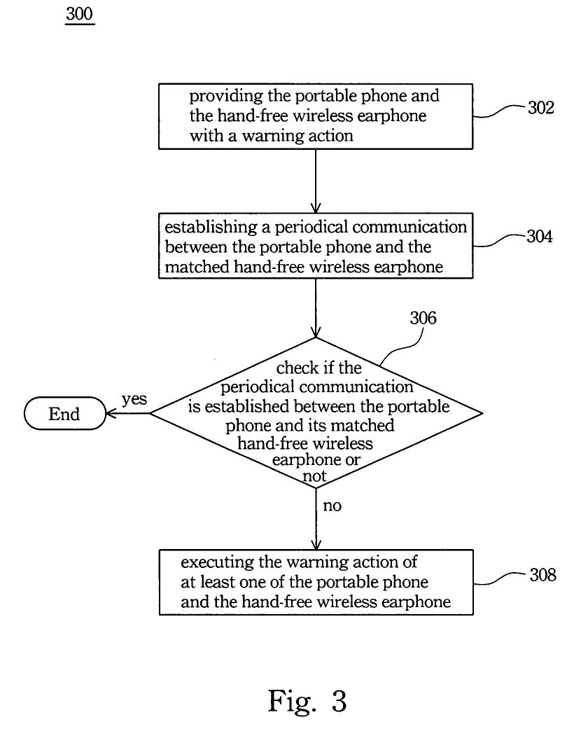

FIG. 3 illustrates another flowchart of a burglarproof mechanism for a portable phone according to another embodiment of this invention. In step 302, a portable phone or its matched hand-free wireless earphone is provided with a specified warning action. In step 304, either one of the portable phone and its matched hand-free wireless earphone sends a radio signal to the other and receives a responsive radio signal from the other periodically. In step 306, a check action is executed to confirm if the periodical communication is established between the portable phone and its matched hand-free wireless earphone or not. When the periodical communication is established between the portable phone and its matched hand-free wireless earphone, the action ends. When the periodical communication is not established between the portable phone and its matched hand-free wireless earphone, a warning action of portable phone or its matched hand-free wireless earphone is executed (step 308).

According to embodiments discussed above, the burglarproof mechanism can prevent a portable phone from theft by providing a warning action of a specified warning sound, a specified warning light-emitting and/or a specified warning vibration to a portable phone owner.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A burglarproof mechanism for a portable phone, comprising:
providing a portable phone with a matched hand-free wireless earphone;
establishing a periodical communication between the portable phone and the hand-free wireless earphone;
providing the portable phone and the hand-free wireless earphone with a warning action;
when the periodical communication is not established, the warning action of at least one of the portable phone and the hand-free wireless earphone is executed.

2. The burglarproof mechanism of claim 1, wherein the hand-free wireless earphone is an earphone of bluetooth communication protocol.

3. The burglarproof mechanism of claim 1, wherein the warning action is a specified warning sound.

4. The burglarproof mechanism of claim 1, wherein the warning action is a specified warning light-emitting.

5. The burglarproof mechanism of claim 1, wherein the warning action is a specified warning vibration.

6. The burglarproof mechanism of claim 1, wherein the warning action is a specified warning sound accompanied with a specified warning light-emitting.

7. The burglarproof mechanism of claim 1, wherein the warning action is a specified warning sound accompanied with a specified warning light-emitting and a specified warning vibration.

8. The burglarproof mechanism of claim 1, wherein the warning action is a specified warning sound accompanied with a specified warning vibration.

9. The burglarproof mechanism of claim 1, wherein the warning action is a specified warning light-emitting accompanied with a specified warning vibration.

10. The burglarproof mechanism of claim 1, further comprising the step of turning on the warning action of the portable phone and the hand-free wireless earphone, after the step of providing the portable phone and the hand-free wireless earphone with the warning action.

11. The burglarproof mechanism of claim 1, wherein the periodical communication comprises:
either one of the portable phone and the hand-free wireless earphone sending a radio signal to the other and receiving a response radio signal from the other.

12. The burglarproof mechanism of claim 1, wherein when the periodical communication is not established, either one of the portable phone and the hand-free wireless earphone fails to receive a radio signal from the other.
